(19) United States
(12) Patent Application Publication
(10) Pub. No.: US 2010/0143867 A1
(43) Pub. Date: Jun. 10, 2010

(54) METHOD FOR PRODUCING A DENTAL RESTORATION

(75) Inventor: Osten Lundahl, Skelleftea (SE)

Correspondence Address: SCHWEGMAN, LUNDBERG & WOESSNER, P.A., P.O. BOX 2938, MINNEAPOLIS, MN, 55402, US

(73) Assignee: CAD.ESTHETICS AB, SKELLEFTEA (SE)

(21) Appl. No.: 11/793,554

(22) PCT Filed: Dec. 20, 2004
(86) PCT No.: PCT/SE2004/001934

§ 371 Date: Jun. 19, 2007

(30) Foreign Application Priority Data
Dec. 19, 2003 (SE) 0303439-4

(51) Int. Cl. A61C 13/00

(52) U.S. Cl. 433/167

(57) ABSTRACT

A method for preparing a dental restoration with at least one rotating material removing tool (2) is presented, the N method comprising the steps of providing a dental material piece (1) from which the dental restoration is to be prepared, providing an initial cavity (C) in the material dental piece (1), and removing material outside the initial cavity (C) by moving the tool (2) essentially in a plane perpendicular to the rotational axis (R) of the tool (2). In hard, brittle dental restoration materials, risks of material failure, excessive tool wear, and tool failure are reduced, and higher processing speeds are made possible.

### TECHNICAL FIELD

The present invention relates to a method for preparing a dental restoration with at least one rotating material removing tool.

### BACKGROUND

Since the 1980:s developments of automated production of dental restorations have been made. Such a production typically include automated acquiring of topographic data from a model made from a bite impression from a dental patient, computer based design of a dental restoration, and automated manufacturing of the dental restoration. For example, CAD/CAM based systems from the design and manufacturing of dental restorations are known from:
Duret: “Vers unit prothese informatisee” Tonus Dentaire No 73, 1985 pp. 55-57.
Duret et al: “CAD-CAM in dentistry”, JADA, Vol. 117, November 1988, pp. 715-720.
Williams: “Dentistry and CAD/CAM: Another French Revolution”, Journal of Dental Practice Administration, January/March 1987.
Sjolin, Sundh, Bergman: “The Decim System for Production of Dental restorations”, International Journal of computerised Dentistry 1999: 3.

In an automated manufacturing of a dental restoration, typically suitable tools, such as cutting tools, are used to form the restoration from a blank, the tools following paths according to a manufacturing program based on a digital model of the dental restoration. Usually, industrial ceramics, such as dense sintered high purity aluminium or yttrium stabilized zirconium, are used as material for the restoration. Such materials present, despite their advantages concerning the esthetical result of the restoration, a number of problems in the manufacturing process. Their hardness result in a high rate of wear on the tools used, which, besides being costly, can result in vibrations in the manufacturing process, in turn causing deviations from tolerance requirements. Also, the nature of the ceramic materials used is such that they are relatively brittle, and therefore caution has to be taken when the tool paths are determined, in order not to avoid the risk of failure in the material. Usually, restriction on the cutting parameters of the tools during the manufacturing process are introduced to decrease tool wear and avoid failure in the blank, which in turn lengthens the process causing a slow production.

### SUMMARY

It is an object of the invention to decrease tool wear in automated manufacturing of dental restorations.

It is another object of the invention to decrease, in automated manufacturing of dental restorations, the risk of a failure in the dental restoration material.

It is another object of the invention to decrease processing time in automated manufacturing of dental restorations.

These objects are reached with a method for preparing a dental restoration with at least one rotating material removing tool, comprising the steps of
providing a dental material piece from which the dental restoration is to be prepared,
providing an initial cavity in the material dental piece, and
removing material outside the initial cavity by moving the tool essentially in a plane perpendicular to the rotational axis of the tool.

In brittle dental materials, to reduce risks of material failure, the working grinding surface of the tool should have a high speed in relation to the material. The speed of the grinding surface of the tool due to the rotation of the latter, is zero at the axis of rotation, which is usually at the tip of the tool. When the tool is moved in a plane perpendicular to the rotational axis of the tool, the area on the grinding surface of the tool having no or little speed will move parallel to the surface of the dental material piece. Therefore, this area will not be substantially involved in the material removal process. Instead, areas of the tool further from the axis of rotation, having a high speed will be involved in the process. Therefore, not only risks of material failure will be reduced, but also, due to the high speed of working grinding surfaces, the tool can be moved at a higher speed, which shortens the processing time of the dental restoration. It is known that dental restoration materials causes a lot of wear on material removal tools. An advantage of the invention is that the high speed of working surfaces of the tool will reduce wear of the tool itself.

When forming a cavity in a dental material using the method according to the invention, movements of the tool in a direction having a component parallel to the rotational axis, causing low speed areas of the tool to take part of the material removing process, can be limited and concentrated to a step of forming an initial, central cavity, and a substantial part of the material removal procedure can be performed by moving the tool perpendicular to the rotational axis.

Preferably, the step of providing an initial cavity includes moving the tool so that the direction of the movement of the tool forms an angle to a rotational axis of the tool.

At a distance from the center of rotation, the surface of the tool has a velocity component due to the tool rotation in a direction which is tangential to the local work piece surface. However, a surface area of the tool close to or at the center of rotation has only a small velocity component or no velocity component due to the rotation of the tool in the tangential direction of the local surface of the work piece. By moving the tool in an angle to the rotational axis of the tool, such an area close to or at the center of rotation will present a velocity component, due to the translational movement of the tool, in the tangential direction of the local surface of the work piece. Thereby, the temperature buildup, and the risk of excessive tool wear and work piece material failure is substantially decreased. Also, since the temperature buildup, and the risk of excessive tool wear and work piece material failure is decreased, the tool can be allowed to remove material at a higher rate.

Also, since the tool is moved in an angle to the rotational axis of the tool, it is assured that an open space will be present close to a tip of the tool, providing for a cooling liquid to be distributed to an area close to the effective working area of the tool.

Preferably, the angle between tool movement direction and the rotational axis of the tool is between 80 and 89.5 degrees. Within this range a high processing speed is allowed with risks of material failure kept low. More specifically, while moving the tool at about 200 mm/min., for relatively hard dental restoration materials a suitable value for said angle is around 89 degrees, and said angle can be decreased to about 85 degrees when working in softer dental restoration materials, giving a high processing speed with little risk of material failure, excessive tool wear or tool failure. Examples of hard dental restoration materials include aluminium oxides and fully sintered yttrium stabilised zirconiumdioxide, and the exceptionally hard, hot isostatic pressed zirconiumdioxide. Relatively soft dental restoration materials include magnesium stabilised zirconiumdioxides.

Preferably, in the step of providing an initial cavity, the tool path, as projected in a plane perpendicular to the rotational axis of the tool, forms a closed loop. Thereby, the tool path could be helical, or present a screw form having an elliptic, rectangular, square, or triangular cross-section. Alternatively, the tool path, as projected in a plane perpendicular to the rotational axis of the tool, could present a closed curve of any suitable, alternative shape. By letting the tool descend into the work material while the tool movement as projected in a plane perpendicular to the tool rotational axis forms a closed loop, the size of the tool surface in contact with the work piece, can be controlled so that it does not exceed a desired level, and is kept, at least substantially, constant.

Preferably, the method comprises
determining a tool center boundary curve, which represents the outer limit of the movements of the rotational axis of the tool, at a plane perpendicular to the axis of rotation of the tool, based on
the intended final cavity surface in a region in the vicinity of an intersection between said intended final cavity surface and said plane perpendicular to the axis of rotation of the tool, and
the shape of the tool on at least a part thereof.

When performing the step of removing material outside the initial cavity, material is removed essentially until an intended final cavity surface of the dental material piece. However, to arrive at the final shape, precision machining has to be performed to smoothen the surface of the dental material piece. This is a time consuming stage of the process of obtaining a dental restoration. By considering, in a preceding stage, the shape of the tool in relation to the intended final cavity surface, the result of such a preceding stage will come closer to the end result. In turn, less material will remain to be removed in a following precision machining stage, and less time will be involved in the latter, contributing to shortening the entire dental restoration production process.

According to a preferred embodiment, the method comprises
determining a tool center curve at each level, of a plurality of levels, at, under and/or above said plane being perpendicular to the axis of rotation of the tool, by offsetting inwards the intersection between the intended final cavity surface and the respective level by an amount corresponding to the radius of the tool at the respective level, and
determining the tool center boundary curve as the most inwardly located of the tool center curves.

This provides a two dimensional calculation at each level, rendering a 2½ dimensional calculation for determining the tool center boundary curve, giving a result, essentially as accurate as a three dimensional calculation. However, compared to the latter, considerably less calculation steps are involved in the preferred embodiment of the inventive method. Therefore, the calculation time, and therefore processing time of the dental restoration can be kept low, in addition to which the method can be performed at a dental technician laboratory having limitations regarding the computational capacity of its computer equipment.

Preferably, the location, in a plane perpendicular to the rotational axis of the tool, of a center of the initial cavity is determined as the location of the center of the largest circle that can be fitted within a boundary curve in a plane perpendicular to the axis of rotation of the tool. Thereby, the step of removing material outside the initial cavity is advantageously performed by moving the tool, from the initial cavity towards the boundary curve, along circular paths or a spiral shaped path. Determining the largest circle, that can be fitted within a boundary curve in a plane perpendicular to the axis of rotation of the tool, has the result that the length of circular paths or a spiral path inside the largest circle is maximized. In turn, this is advantageous since the effective grinding area of the tool can be controlled and variations in the effective grinding area can be kept at a minimum.

Preferably, at least one tool path is determined by creating at least one offset curve by offsetting outwards a curve, and trimming the at least one offset curve against a tool boundary curve. As will be explained further below, this has the advantages that the cutting depth of the tool can be controlled, and that it is easy to check if the tool paths result in extraordinary movements that are undesired from a material processing point of view, e.g. due to a risk of damaging the material or the tool.

### BRIEF DESCRIPTION OF THE DRAWINGS

Additional advantages of the invention will be presented in the description below, in which the invention will be described in detail with the aid of the drawings, in which

FIGS. 1, 4, and 9-17 show cross-sections of a dental material piece from which a dental restoration is to be prepared, in different stages of a method according to one embodiment of the invention,

FIG. 2 shows a perspective view depicting a tool and its movement,

FIG. 3 shows a side view of the tool in FIG. 2 in action,

FIG. 5 shows a view of a detail of the tool and a detail of the dental material piece,

FIG. 6 depicts tool boundary curves,

FIG. 7 shows a sectioned view of the dental material piece, whereby the section is oriented perpendicular to a rotational axis of the tool, and

FIGS. 8a, 8b, and 8c show tool paths projected in a plane perpendicular to a rotational axis of the tool.

### DETAILED DESCRIPTION

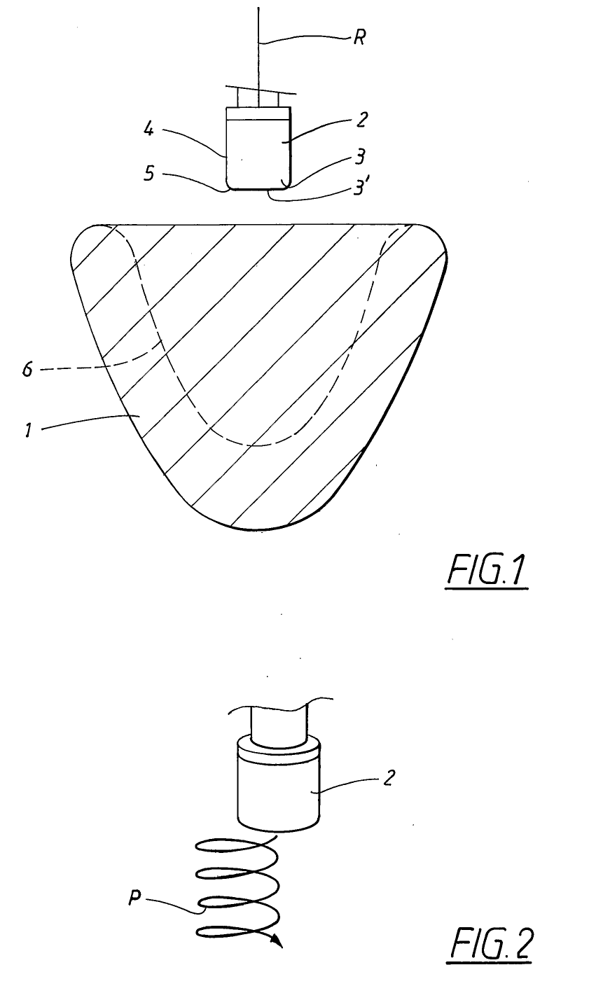

FIG. 1 shows a cross-section of a dental material piece 1 from which the dental restoration is to be prepared. The dental restoration could be a crown, a part-crown, an inlay, an onlay, a bridge, a stump reconstruction, a veneer, also referred to as a ligament, a facette, a filling or a connector. The dental restoration could be formed according to a digital model, in turn obtained by scanning of a model, obtained from a bite impression, and a computer aided design process based on the scanning data, known in the art. The dental material piece 1 could be a blank, or the result of an already initiated material removal process on a blank. For example, an exterior surface of the dental restoration could be at least partly finished, before commencing the steps of the method according to the invention.

The dental material of the piece 1 could be a ceramic material based on zirconium oxide, aluminium oxide or any other suitable material. The dental material piece 1 is mounted in a machine with at least one holder (not shown in FIG. 1).

In the machine any suitable material removing tool 2 can be arranged, such as a milling tool or a cutting tool, suitable for working on the material for the restoration, whereby the tool is adapted to move automatically in relation to the dental material piece 1 according to instructions in a program file run in a computer program. The rotational axis of the tool 2 is indicated in FIG. 1 with a line R. The tool presents a cylindrical grinding surface 4, and an essentially flat grinding surface 3′ at the tip region 3, which flat grinding surface is oriented essentially perpendicular to the rotational axis R. A radius 5 is provided at the intersection of the flat grinding surface 3′ and the cylindrical grinding surface 4. Alternatively, the grinding part of the tool could have another shape, e.g. of a truncated cone or a sphere.

The tool is to be used in a process of removing material to obtain a cavity of the dental restoration. In FIG. 1 the dental material piece 1 is shown sectioned parallel to the rotational axis R of the tool 2. A contour of the intended cavity is indicated with the broken line 6.

Referring to FIG. 2, in a step according to a preferred embodiment of the invention, an initial cavity is formed in the dental material piece, by moving the tool 2 while in rotation, wherein the tool follows a helical path. In FIG. 2, the helical path is indicated as a path followed by a center of the tool 2, and indicated by a curved arrow P. Thus, the path P forms an imaginary screw. To avoid material remaining at the center of the bore formed by the tool, the diameter of this screw is less than the diameter of the tool itself.

The helical path described results in the effective working surface of the tool being substantially constant during this step of the method. However, as an alternative to the helical motion described, it is possible to move the tool along another descending path with a different shape when projected in a plane perpendicular to the rotational axis R of the tool. Thus, the shape of the path projected in a plane perpendicular to the rotational axis R of the tool could be elliptic, rectangular, square or triangular. Alternatively, the path P formed in this step of the method is not closed when projected in a plane perpendicular to the rotational axis R, whereby it is simply a curved or straight declining path.

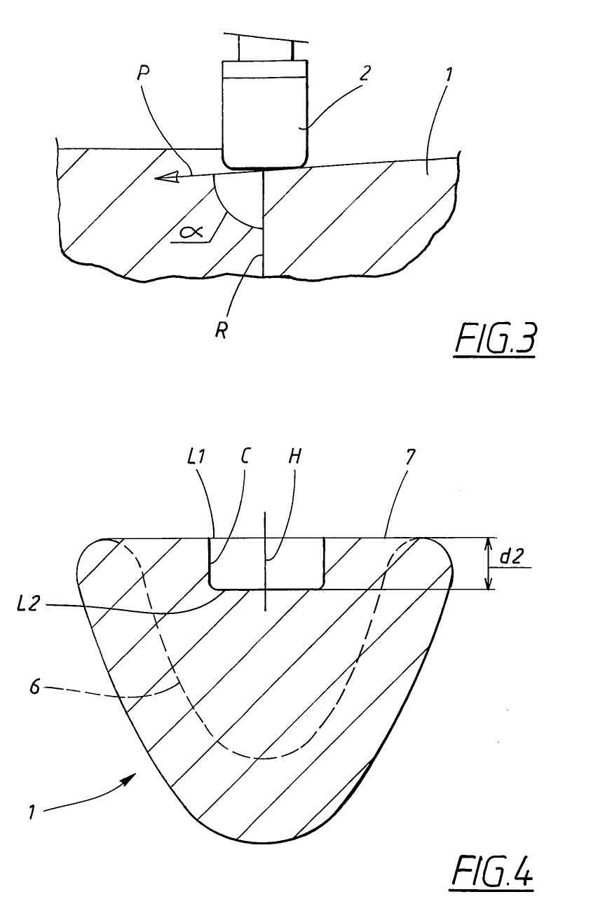

Referring to FIG. 3, during the step described with reference to FIG. 2, the tool 2 is moved so that the direction of the movement P forms an angle α to the rotational axis R of the tool 2. If the tool is moved at a velocity of about 200 min/min, the angle α is suitably about 89 degrees for hard dental restoration materials, and down to 85 degrees for less hard dental restoration materials. Thereby, the material removal rate can be kept relatively high, at the same time avoiding the risk of material failure, excessive tool wear or tool failure due to high temperatures in the effective grinding region.

FIG. 4 shows the result of the step described above with reference to FIGS. 2 and 3. An initial substantially cylindrical central cavity C has been formed with a diameter essentially equal to the diameter of the screw of the helical path P added to the tool diameter. Material has been removed from a first level L1 of the dental material piece 1 to a second level L2 thereof, the first and the second level L1, L2 being separated by a distance d2 in a direction parallel to the rotational axis of the tool. Here the expression “level” means an imaginary flat plane perpendicular to the rotational axis R.

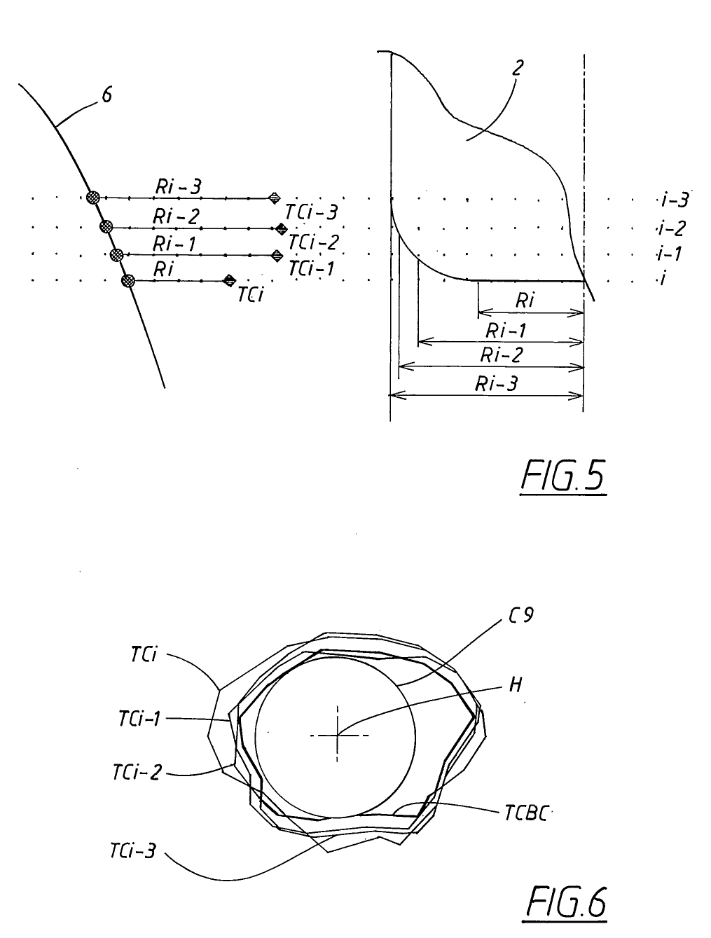

Referring to FIGS. 5 and 6, at the second level L2, a tool center boundary curve TCBC is determined, which represents the outer limit of the movements of the rotational axis R of the tool, at the second level L2. The determination of the tool center boundary curve TCBC is based on the intended final cavity surface 6 (FIG. 4) in a region in the vicinity of an intersection between said intended final cavity surface 6 and the second level L2, and also the shape of the tool.

Referring to FIG. 5, more specifically a tool center curve TCi, TCi-1, TCi-2, TCi-3 is i-2, i-3. The levels, i, i-1, i-2, i-3, which can be of any suitable number, can be located at, under and/or above the level L2, but in this example, one level, i, is identical to the second level L2, and the remaining levels, i-1, i-2, i-3, is distributed above the second level L2. At each level, i, i-1, i-2, i-3, a line formed by the intersection between the intended final cavity surface 6 and the respective level i, i-1, i-2, i-3 is offset inwards by an amount corresponding to the radius Ri, Ri-1, Ri-2, Ri-3 of the tool 2 at the respective level, i, i-1, i-2, i-3, whereby a tool center curve, TCi, TCi-1, TCi-2, TCi-3, is determined at each level, i, i-1, i-2, i-3.

Referring to FIG. 6, the tool center boundary curve TCBC, indicated in FIG. 6 with a bold line, is determined as the most inwardly located at each segment of the tool center curves, TCi, TCi-1, TCi-2, TCi-3.

Preferably, a step of removing material outside the initial cavity C by moving the tool 2 essentially in a plane perpendicular to the rotational axis R of the tool 2, includes moving the tool 2 along concentric circular paths. To provide for obtaining a maximum length of such circular paths, a center H (see FIG. 4) of the initial cavity C described above with reference to FIGS. 2 and 3 is determined in the following way:

Referring to FIG. 6, the center H of the initial cavity C is determined as the location of the center of the largest circle C9 that can be fitted within a the tool center boundary curve TCBC. Alternatively, the center H of the initial cavity C can be determined as the location of the center of the largest circle that can be fitted within some other boundary curve, for example, the intersection between the second level L2 and the intended cavity surface 6, (see FIG. 4).

Thus, the center of this circle C9 is the lateral position of the center of the screw formed by the helical path P described above with reference to FIG. 2. Accordingly, preferably, the tool center boundary curve TCBC at the second level L2 is determined before creating the initial cavity C.

Following the step of providing an initial cavity C, material is removed between the first and the second level L1, L2 by moving the tool 2 while in rotation essentially in a plane perpendicular to the rotational axis R of the tool 2. Material is to be removed approximately until the intended cavity surface at the second level L2.

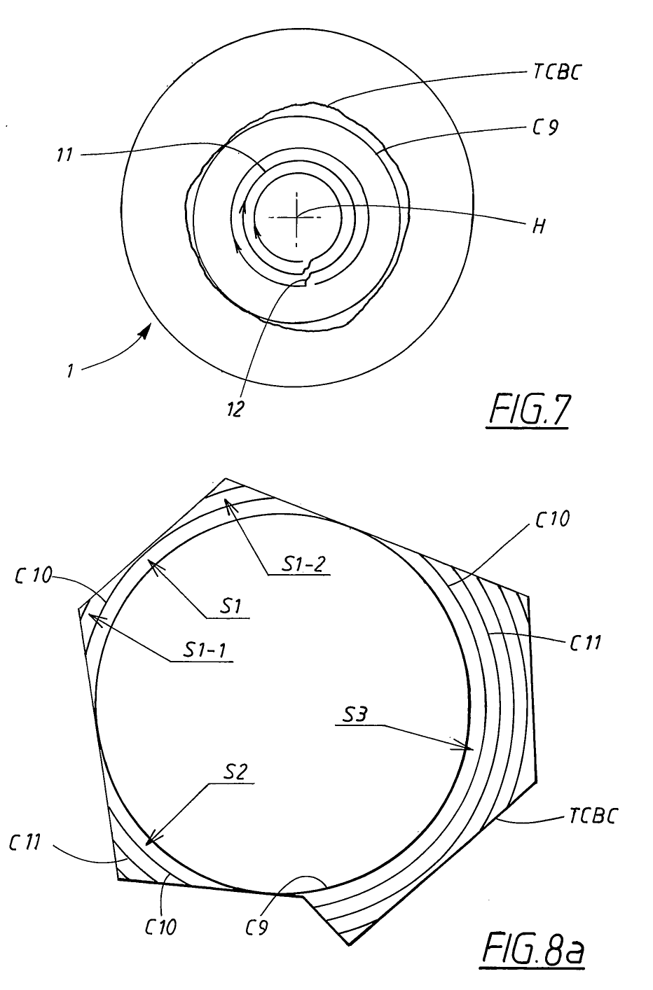

FIG. 7 shows, in a cross-section perpendicular to the rotational axis of the tool, a step following the step of providing an initial cavity. The movements of a center position of the tool 2 at the rotational axis R thereof, are indicated with lines with arrows.

The movements have directions essentially perpendicular to the rotational axis R of the tool 2. The movements follow circular tracks 11 essentially centered on the center H of the initial cavity C, and presenting suitable differences in radiuses, whereby an orbit of the center position of the tool 2 following one circular track is followed by a step 12 outwards to a larger circular track.

In the step described in with reference to FIG. 7, at each orbit of the tool 2, material is removed mainly by the grinding surface 4, (see FIG. 1). Depending on the size and rotational speed of the tool 2, and the type of dental restoration material used, a suitable amount of material is removed at each orbit of the tool 2.

Of course, regarding the movements of the tool there are a number of alternatives to the circular tracks separated with radial steps, described with reference to FIG. 7. For example, while moving the tool 2 essentially in a plane perpendicular to the rotational axis R, the tool could, at least at an early phase of the step of removing material between the first and the second level L1, L2, follow a track shaped as a spiral, at which the tool is gradually moved outwards from the starting point, so that a suitable amount of material is removed at each orbit of the tool.

The movements of the tool 2 essentially in a plane perpendicular to the rotational axis R has the following advantage: Since the grinding surface 4 of the tool 2 is at a radial distance from the rotational axis R, and since the grinding surface 4, due to the lateral movement of the tool, takes part in the material removing process, it is accomplished that essentially all of the working grinding surface of the tool 2 has a high velocity. This results in a high material removal rate. The nature of dental restoration materials, i.e. dental ceramic materials, includes a relatively small elastic deformation and essentially no plastic deformation before a breaking stress of the material is reached. As a result, if some working surfaces of the tool is moving due to the rotation with a relatively slow velocity, the translational movement of the tool combined with a relatively small material removal rate, could cause deformations in the dental restoration material followed by a failure when the ultimate stress has been reached. The high velocity of the working grinding surface of the tool 2 accomplished by the invention will drastically reduce the risk of failure in the dental restoration material.

In general, the method according to the invention drastically reduces the risk of damages on materials or tools by making it possible to prevent the cutting depths from becoming too large, (discussed closer below), to avoid or minimise movements mainly in the axial direction of the tool, and to prevent a contact surface between the tool and the material from becoming too large, (discussed closer below).

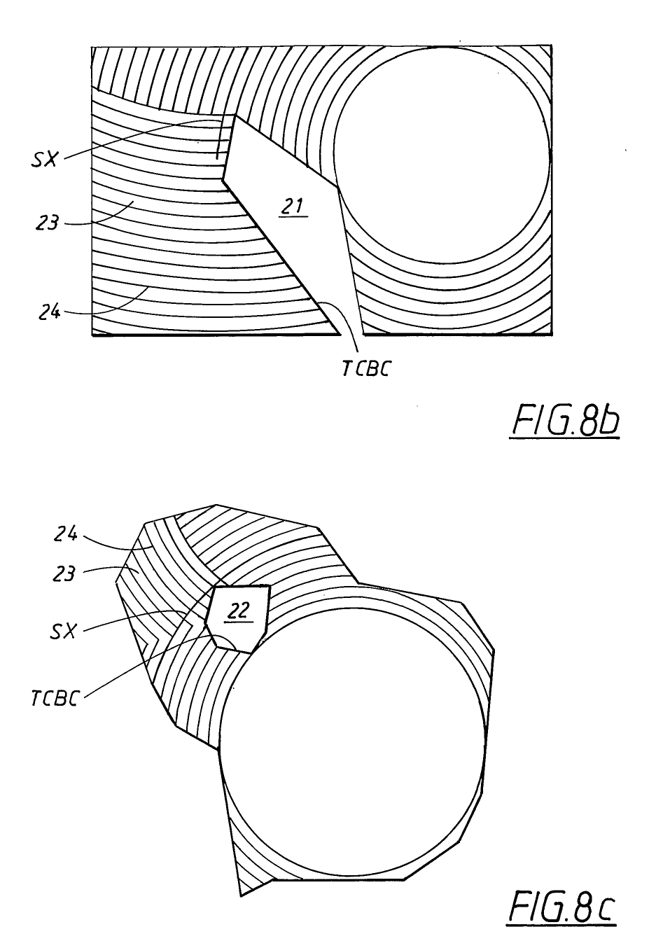

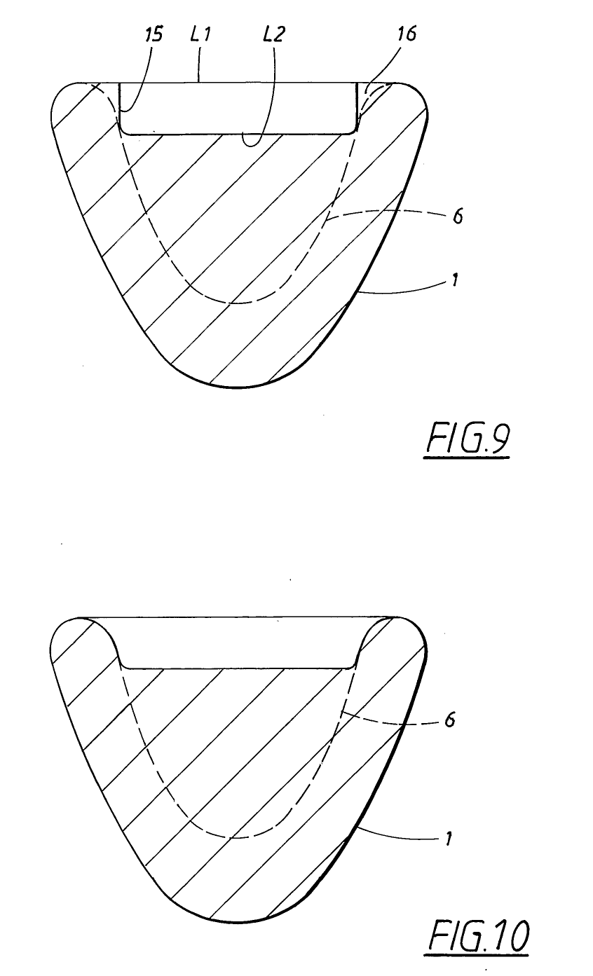

Referring to FIG. 7, the tool center boundary curve TCBC has an irregular shape. Referring to FIG. 8a, the movements of the tool is limited outwards by the TCBC, and tool paths in the area enclosed by the tool center boundary curve TCBC are determined in the following way: A curve, in this example the circle C9, is offset outwards to form tool paths C10, C11 outside this curve C9, which paths has shapes corresponding to the shape of said curve C9. Instead of offsetting from a circle C9, the outwards offsetting could be made from any suitable curve, with any shape. As a further alternative, the tool paths can be determined as outwardly offsetting curves of a predetermined shape, for example circles or circle segments, from a point with a suitable location.

The distance between the offset curves C10, C11 corresponds to a suitable radial cutting depth of the tool 2.

Curves created by outwards offsetting can intersect the tool center boundary curve TCBC. Additional outer tool paths are created by outwards offsetting, until created curves do not intersect the tool center boundary curve TCBC, i.e. are located outside the latter.

Where needed, the offset curves are trimmed against the tool center boundary curve TCBC, removing curve parts outside the latter, so that segments C10, C11 of closed curves or circles are created. Such segments, or clusters of segments, form sections S1, S2, S3 of the processing region, which sections are formed in pockets inside the tool center boundary curve TCBC, where the latter presents a more abrupt curvature than the curves C10, C11 created by outwards offsetting. Each section, (for example S1 in FIG. 8a), can present subsections S1-1, S1-2 which are smaller sections or pockets, each with their own curve segments.

Preferably, in each section S1, S2, S3, (pocket inside the TCBC), and in each subsection S1-1, S1-2, the curve segments C10, C11 are interconnected to form a continuous tool path. Preferably, the interconnection between the segments are formed by interconnecting segments of the TCBC, or by linear segments taking into account a suitable clearance towards the TCBC. Thus, when removing material, the tool paths within a section S1, S2, S3, or a subsection, S1-1, S1-2, are followed successively to minimise the number of tool lifting measures between different sections or pockets S1, S2, S3. This will reduce the processing time.

A precision cut following the tool center boundary curve TCBC is made to clean the contour.

An advantage with the technique of determining tool paths by offsetting outwards a curve, and trimming offset curves against a boundary curve TCBC is that the cutting depth of the tool can be controlled.

Another advantage is that it is easy to check if the tool paths result in extraordinary movements that are undesired from a material processing point of view, e.g. due to a risk of damaging the material or the tool. For example, referring to FIGS. 8b and 8c, such a case can arise when a tool path stretches into a “shaded” area, e.g. behind a “peninsula” 21 or an island 22 formed by the tool center boundary curve TCBC. Such a shaded tool path is marked with “SX” in FIGS. 8b and 8c. Since material has not been removed inside of the shaded tool path the contact surface of the material and the tool becomes very large. The appearance of the shaded path as such is easy to detect, when using the technique of offsetting a curve outwards.

Preferably, if a tool path is found to be undesired according to predetermined requirements, e.g. regarding the size of the contact surface of the material and the tool, the tool path is rejected. Preferably, a region 23 is defined including an area covered by the rejected tool path SX, and a set of curved, preferably part-circular, tool paths 24 are defined with a suitable center of curvature and radiuses. Alternatively, such tool paths 24 can be straight.

FIG. 9 shows, in a view of the dental material piece 1 sectioned as in FIGS. 1 and 4, a result of the step described above, to remove material between the first and the second level L1, L2, in the form of a cavity 15. It can be seen that material has been removed approximately up to the contour 6 of the intended final cavity, at the second level L2. It can be seen that a portion 16 of the dental material piece 1, outside the cavity 15, and between the cavity 15 and the contour 6 remains to be removed. Preferably, this is done by introducing a number of sublevels between the first and second levels L1, L2, and, starting from the lowest sublevel and raising the tool in a stepwise manner, removing material at each sublevel. Similar to what was described above with reference to FIGS. 5 and 6, at each sublevel, i-1, i-2, i-3, a tool center boundary curve, TCBCi-1, TCBCi-2, TCBCi-3, is determined. At each sublevel, for example on sublevel i-2, tool paths are created by offsetting outwards the tool center boundary curve TCBCi-1 from the sublevel below, i-1, towards the tool center boundary curve TCBCi-2 at the sublevel i-2. The result is shown in FIG. 10.

In this example, the processing of the dental restoration continues with similar steps as those described above. Referring to FIG. 11, in a step corresponding to the step described above with reference to FIGS. 2, 3, and 4, material is removed from the dental material piece 1 from a first level L1 of the dental material piece 1 to a second level L2 thereof, the first and the second level L1, L2 being separated by a distance d2 in a direction parallel to the rotational axis of the tool. In this example, the first level L1 in the step described with reference to FIG. 11, is the same as the second level L2 in the step described with reference to FIG. 4.

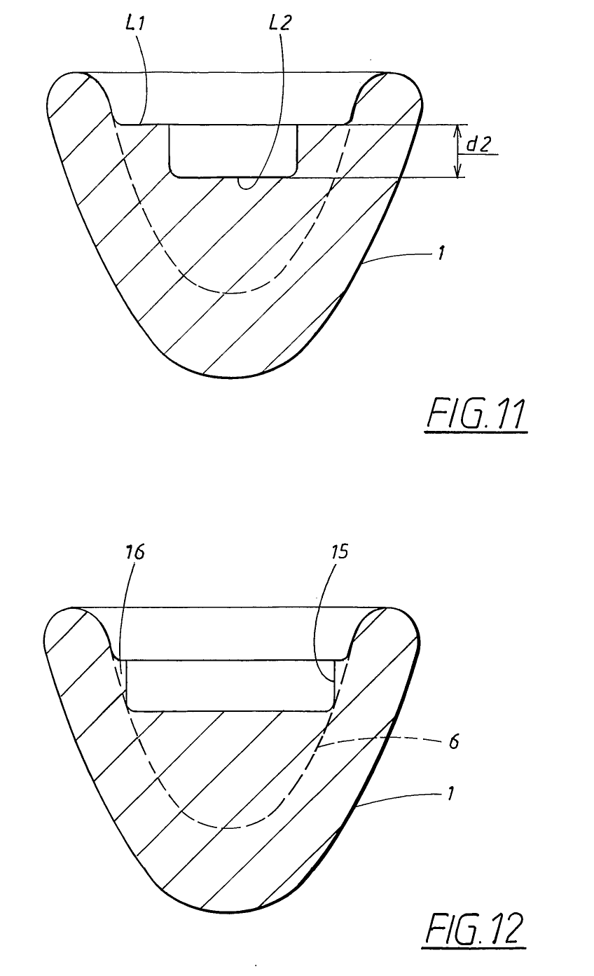

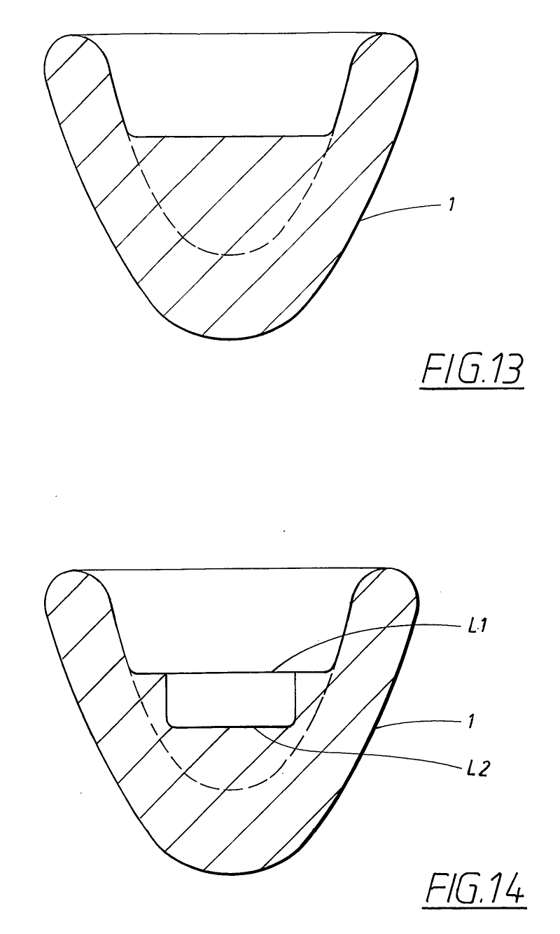

According to the invention, in a subsequent step, material is removed between the first and the second level L1, L2 by moving the tool 2 while in rotation essentially in a plane perpendicular to the rotational axis R of the tool 2, the result of which is shown in FIG. 12. This is done in the same manner as described above with reference to FIGS. 7 and 8a. Similar to what has been described with reference to FIG. 9, it can be seen that a portion 16 of the dental material piece 1, outside the cavity 15, and between the cavity 15 and the contour 6 remains to be removed. In the same manner as described above with reference to FIGS. 9 and 10, this is done by introducing a number of sublevels between the first and second levels L1, L2, and, starting from the lowest sublevel and raising the tool in a stepwise manner, removing material at each sublevel. The result is shown in FIG. 13.

Referring to FIG. 14, continuing the processing of the dental restoration with similar steps as those described above, in a step according to the invention, material is removed from the dental material piece 1 from a first level L1 of the dental material piece 1 to a second level L2 thereof. In this example, the first level L1 in the step described with reference to FIG. 14, is the same as the second level L2 in the step described with reference to FIG. 11.

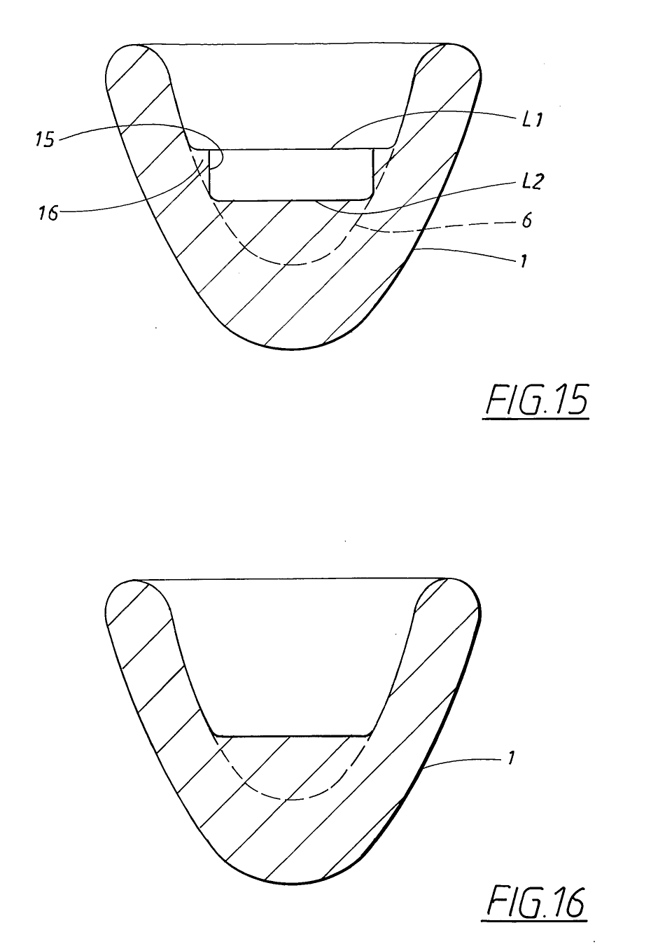

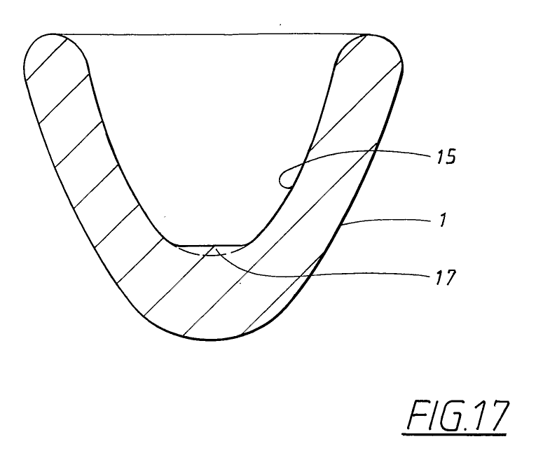

Similar as described above with reference to FIGS. 7 and 8a, in a subsequent step, material is removed between the first and the second level L1, L2 by moving the tool while in rotation essentially in a plane perpendicular to the rotational axis R of the tool 2, the result of which is shown in FIG. 15. FIG. 16 shows the result of removing a portion 16, shown in FIG. 15, outside the cavity 15, and between the cavity 15 and the contour 6.

Preferably, the lowest level for using the tool 2, used in the steps described above, is a level that permits creating an initial cavity C of a predetermined minimum diameter, so that it is ensured, during the creation of the initial cavity C, that the direction of the movement of the tool 2 forms an angle α to a rotational axis R of the tool.

FIG. 17 shows the dental material piece 1 after removing further material in a similar manner to what has been described above, whereby a cavity 15 is obtained. A portion 17 at the bottom of the cavity 15 can be removed by a suitable tool.

Levels processed by the relatively large tool 2 are analysed regarding areas not processed due to the size of the tool 2. Preferably, this analysis is performed from the bottom and up. At each level an inner curve is determined based on the processed area. The inner curve is expanded outwards similarly to what has been described above with reference to FIG. 8a, to create tool paths to remove remaining areas. This is done with a suitable tool with smaller dimensions.

Above, the cavity in the dental material piece 1 has been described as being created by two steps being repeated alternately, namely: providing an initial cavity C in the material dental piece 1, and removing material outside the initial cavity C. It should be noted that these steps can be carried out using the same or different tools.

Alternatively, a step of providing an initial cavity C in the material dental piece 1 can be followed by repeated steps of removing material outside the initial cavity C, whereby the initial cavity C is relatively deep and material is removed outside of the initial cavity at a plurality of levels. Thereby, initial cavities or pre-cavities, can be pre-made in dental restoration blanks or work pieces. In such a case, the initial cavity C can advantageously be formed before sintering of the material, or, when compression moulding the blanks, the initial cavity C can be formed by providing a protruding part in the mould.

1. A method for preparing a dental restoration with at least one rotating material removing tool, comprising
providing a dental material piece from which the dental restoration is to be prepared,
providing an initial cavity in the material dental piece, and
removing material outside the initial cavity by moving the tool essentially in a plane perpendicular to the rotational axis of the tool.

2. A method according to claim 1, wherein providing an initial cavity includes moving the tool so that the direction of the movement of the tool forms an angle to the rotational axis of the tool.

3. A method according to claim 2, wherein the angle is between 80 and 89.5 degrees.

4. A method according to claim 3, wherein, in the step of providing an initial cavity the tool path, as projected in a plane perpendicular to the rotational axis of the tool, forms a closed loop.

5. A method according to claim 4, wherein the tool follows a helical path.

6. A method according to claim 5, further comprising:
determining a tool center boundary curve, which represents the outer limit of the movements of the rotational axis of the tool, at a plane being perpendicular to the axis of rotation of the tool, based on the intended final cavity surface in a region in the vicinity of an intersection between said intended final cavity surface and said plane being perpendicular to the axis of rotation of the tool, and the shape of the tool on at least a part thereof.

7. A method according to claim 6, comprising
determining a tool center curve at each level, of a plurality of levels, at, under and/or above said plane being perpendicular to the axis of rotation of the tool, by offsetting inwards the intersection between the intended final cavity surface and the respective level by an amount corresponding to the radius of the tool at the respective level and determining the tool center boundary curve as the most inwardly located of the tool center curves.

8. A method according to claim 7, wherein the location, in a plane perpendicular to the rotational axis of the tool, of a center of the initial cavity is determined as the location of the center of the largest circle that can be fitted within a boundary curve in a plane perpendicular to the axis of rotation of the tool.

9. A method according to claim 8, wherein said boundary curve is the tool center boundary curve.

10. A method according to claim 8, wherein at least one tool path is determined by creating at least one offset curve by offsetting outwards a curve, and trimming the at least one offset curve against a tool boundary curve.

11. A method according to claim 10, wherein, if a tool path is found to be undesired according to predetermined requirements, the tool path is at least partly rejected, and at least one tool path is defined with a center of curvature differing from that of the rejected tool path.

12. A method according to claim 10, wherein at least one of the tool paths is circular or part-circular.

13. A method according to claim 11, wherein at least one of the tool paths is circular or part-circular.

14. A method according to claim 2, wherein, in the step of providing an initial cavity, the tool path, as projected in a plane perpendicular to the rotational axis of the tool, forms a closed loop.

15. A method according to claim 14, wherein the tool follows a helical path.

16. A method according to claim 15, further comprising: determining a tool center boundary curve, which represents the outer limit of the movements of the rotational axis of the tool, at a plane being perpendicular to the axis of rotation of the tool, based on the intended final cavity surface in a region in the vicinity of an intersection between said intended final cavity surface and said plane being perpendicular to the axis of rotation of the tool, and the shape of the tool on at least a part thereof.

17. A method according to claim 16, comprising
determining a tool center curve at each level, of a plurality of levels, at, under and/or above said plane being perpendicular to the axis of rotation of the tool, by offsetting inwards the intersection between the intended final cavity surface and the respective level by an amount corresponding to the radius of the tool at the respective level, and
determining the tool center boundary curve as the most inwardly located of the tool center curves.

18. A method according to claim 17, wherein the location, in a plane perpendicular to the rotational axis of the tool, of a center of the initial cavity is determined as the location of the center of the largest circle that can be fitted within a boundary curve in a plane perpendicular to the axis of rotation of the tool.

19. A method A method for preparing a dental restoration in a dental material piece with at least one rotating material removing tool, comprising:
providing an initial cavity in the material dental piece, and
removing material outside the initial cavity by moving the tool essentially in a plane perpendicular to the rotational axis of the tool, and
determining at least one tool path by creating at least one offset curve by offsetting outwards a curve and trimming the at least one offset curve against a tool boundary curve.

20. A method according to claim 19, further comprising:
determining a tool center curve at each level, of a plurality of levels, at, under and/or above said plane being perpendicular to the axis of rotation of the tool, by offsetting inwards the intersection between the intended final cavity surface and the respective level by an amount corresponding to the radius of the tool at the respective level, and determining the tool center boundary curve as the most inwardly located of the tool center curves wherein the location, in a plane perpendicular to the rotational axis of the tool, of a center of the initial cavity is determined as the location of the center of the largest circle that can be fitted within a boundary curve in a plane perpendicular to the axis of rotation of the tool.
